(19) United States
(12) Patent Application Publication
(10) Pub. No.: US 2014/0160890 A1
(43) Pub. Date: Jun. 12, 2014

(54) SYSTEM AND METHOD FOR DETERMINING SHEAR WAVE ANISOTROPY IN A VERTICALLY TRANSVERSELY ISOTROPIC FORMATION

(71) Applicants: Xinding Fang, Houston, TX (US); Chung Chang, Houston, TX (US); Arthur Chuen Hon Cheng, Houston, TX (US)

(72) Inventors: Xinding Fang, Houston, TX (US); Chung Chang, Houston, TX (US); Arthur Chuen Hon Cheng, Houston, TX (US)

(21) Appl. No.: 14/232,749

(22) PCT Filed: Aug. 5, 2011
(86) PCT No.: PCT/US2011/046779

§ 371 Date: Jan. 14, 2014

(51) Int. Cl. G01V 1/30

(52) U.S. Cl. CPC G01V 1/307; G01V 1/40
USPC 367/35

(57) ABSTRACT

A system and method for determining shear wave anisotropy in a vertically transversely isotropic formation is disclosed. The method includes generating a broad band Stoneley wave and a broad band dipole flexural wave. The broad band Stoneley wave and a broad band dipole flexural wave may be generated at a logging tool located within a wellbore. The method also includes receiving at the logging tool first data corresponding to the broad band Stoneley wave and second data corresponding to the broad band dipole flexural wave. The method also includes determining a vertical shear wave constant, c66, by at least applying an inversion algorithm to the first data and the second data.

### BACKGROUND

The present disclosure relates generally to well logging and measurement in subterranean formations and, more particularly, the present disclosure relates to a system and method for determining shear wave anisotropy in a vertically transversely isotropic (“VTI”) formation.

Acoustic logging may be used to determine the slowness of a subterranean formation. The slowness or velocity of a subterranean formations may be directionally dependent, such that the slowness or velocity of the formation changes depending on the direction of acoustic wave propagation and its associated polarization. The slowness variation directional or polarization dependence is called seismic anisotropy, which is described by a formation stiffness tensor. In a transversely isotropic formation with the symmetric axis along the borehole axis, a dipole flexural wave is currently used to provide information on a horizontal shear wave modulus, c₄₄, while a Stoneley wave is currently used to provide information on a vertical shear wave modulus, c₆₆. Stoneley waves, however, are sensitive to drilling mud velocity, which is not measured directly, and lead to distorted and unreliable anisotropy measurements. What is needed is a way to reliably and robustly determine both the shear elastic constants c₄₄ and c₆₆, and a mud velocity in the borehole.

### FIGURES

Some specific exemplary embodiments of the disclosure may be understood by referring, in part, to the following description and the accompanying drawings.

FIG. 1 illustrates a well with an example logging system.

FIG. 2 illustrates an example acoustic measurement system.

FIG. 3 illustrates a dispersion chart comparing Stoneley wave and dipole flexural wave sensitivity to anisotropy in fast shale.

FIG. 4 illustrates an example method according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates generally to logging and measurement tools used in subterranean formations and, more particularly, the present disclosure relates to a system and method for determining shear wave anisotropy in a vertically transversely isotropic formation.

Illustrative embodiments are described in detail herein. In the interest of clarity, not all features of an actual implementation may be described in this specification. It will of course be appreciated that in the development of any such actual embodiment, numerous implementation-specific decisions must be made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the invention. Embodiments of the present disclosure may be applicable to horizontal, vertical, deviated, or otherwise nonlinear wellbores in any type of subterranean formation. Embodiments may be applicable to injection wells as well as production wells, including hydrocarbon wells.

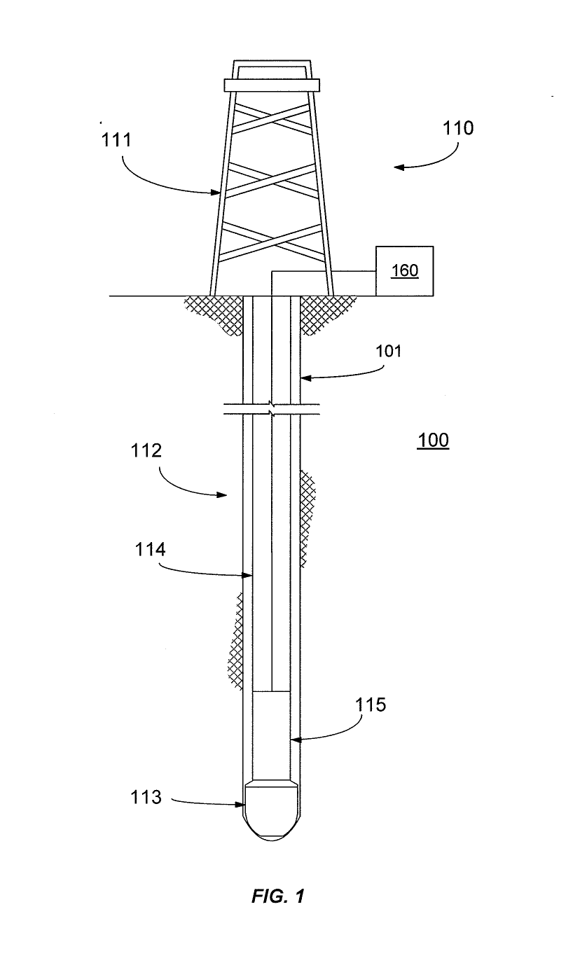

FIG. 1a illustrates a formation 100 that contains a deposit of a desirable fluid such as oil or natural gas. The formation 100 may comprise a vertically transversely isotropic formation, such as shale. A vertically transversely isotropic formation describes a formation with physical properties which are symmetric within bands normal to a plane of isotropy. To extract fluid from the formation 100, a wellbore 101 may be drilled in the formation 100 using a drilling system 110. In the example drilling system 110 shown in FIG. 1, a drilling rig 111 may be coupled to a drill string 112, which in turn couples to a drill bit 113. As used herein, a drill string is defined as including drill pipe 114, one or more drill collars 115, and a drill bit 113. The term “couple” or “couples” used herein is intended to mean either an indirect or direct connection. Thus, if a first device “couples” to a second device, that connection may be through a direct connection or through an indirect connection via other devices or connectors. Drill string 112 may include a rotary-steerable system (not shown) that drives the action of drill bit 113 from the surface. The action of drill bit 113 gradually wears away the formation, creating and extending well 101. As the depth of well 101 increases, drill operators add additional drill pipe and/or drill collar segments to drill string 112, allowing drill bit 113 to progress farther into formation 100.

Testing tools may be incorporated into the drill string for logging while drilling (“LWD”) and measurement while drilling (“MWD”) operations. For example, acoustic measurement tools may be included as part of the drill string or the drill collar. Measurement tools within the drill string or drill collar may be electronically coupled to a control unit 160 on the surface. Measurements gather at a downhole may be stored downhole in a storage medium or transmitted through a wireline or wireless connection to the control unit 160. Power may be provided to the measurement tools via a downhole power source, such as a battery, a generator or from a surface power source. In certain other embodiments, similar acoustic measurement tools may be used in wireline operations, sent downhole separate from a drill string.

The drilling system 110 may also include one or more processors. For example, control unit 160 may include a processor to analyze data received at a downhole measurement tool. Although FIG. 1 shows control unit 160 with the processor at a surface location, a separate control unit and processor may be located inside well 101, or it may be located at or near the sea floor if drilling occurs underwater. For example, a control unit with a processor may be located inside drill bit 113 or in drill string 112. In other embodiments, the drilling system may include multiple processors, one of which is located in drill bit 113 or elsewhere in the drill string along with data storage equipment.

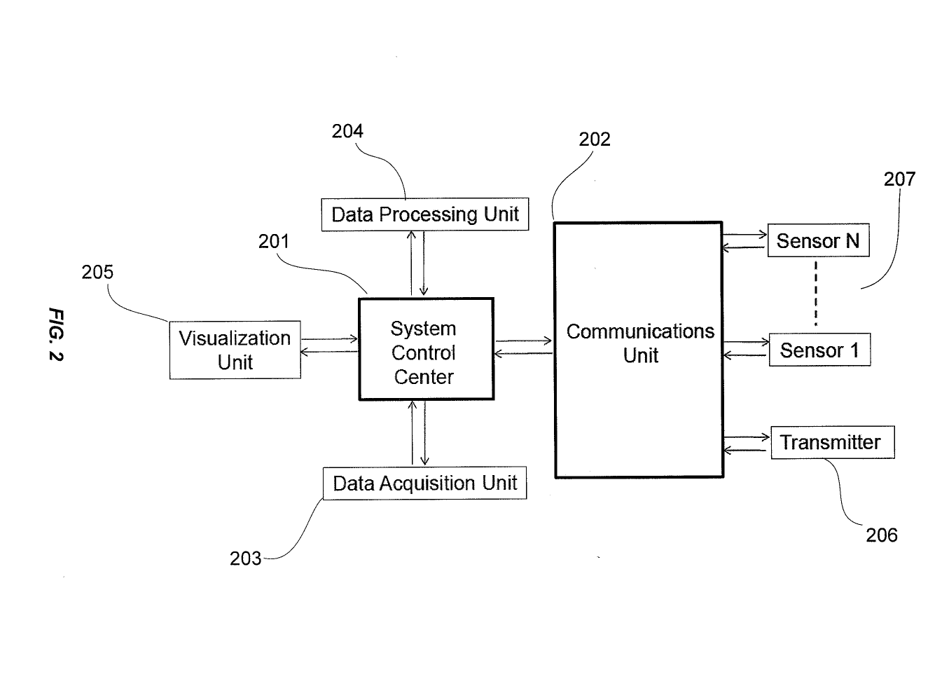

FIG. 2 illustrates an example acoustic measurement system, which can be incorporated into a drilling system similar to the drilling system described above, or which may be incorporated into a wireline measurement operation. Operational procedures may be managed by a system control center 201. System control center 201 may be located at the ground or inside the wellbore, disposed in downhole equipment. For example, the system control center may be incorporated into a control unit on the surface, such as control unit 160 in FIG. 1.

The systems control center 201 may communicate bi-directionally with the transmitter 206 and sensors 207 of an acoustic measurement tool via a communications unit 202. Although a single transmitter is shown in the FIG. 1b, multiple transmitters may be used in some embodiments. The transmitter 206 may transmit energy, such as acoustic waves, into the formation. The system control center 201 may at least partially control the generation of acoustic waves that are transmitted into a formation. Likewise, the system control center 201 may receive measurements of acoustic data received at sensors 207. Sensors 207 may be of monopole type, dipole type, or a higher order type, as will be appreciated by one of ordinary skill in the art with the benefit of this disclosure.

Sensors 207 may measure energy received from the formation, such as acoustic waves reflected from the formation. The type of a sensor may be changed electrically by adjusting the phases of its poles. For example, if a sensor has two poles that are in phase, the resulting sensor is a monopole type sensor. On the other hand, if two poles area 180° out of phase, the sensor would be a dipole type sensor.

A data acquisition unit 203 may communicate bidirectionally with the system control center 201 and may store measurements from the sensors. The data acquisition unit may be included in a separate system 203 from the system control center 201, or may be implemented with the system control center in a control unit, such as the control unit in FIG. 1. The measurement be processed with a data processing unit 204 to determine a formation characteristic, such as slowness information or shear wave properties. The data processing unit 204, such as a processor from a computer system, may also communicate bidirectionally with the system control center 201, and may be included in a control unit with the system control center 201 and the data acquisition unit 203. A visualizing unit 205 may comprise a computer monitor, for example, and may allow users to monitor the data and interrupt system operation if necessary.

At least one transmitter, such as transmitter 206 in FIG. 2, transmits energy into a formation. As used herein, the term “formation” includes mineral beds and deposits, including vertically transversely isotropic formations such as shale. As used herein, the term “energy” includes acoustic waves in all their forms. These waves may be characterized by a frequency and a velocity. The acoustic waves may induce certain waveforms within the formation, such as primary waves (“P-waves”), secondary waves (“S-waves”), Stoneley waves, and flexural waves. The waves may radiate within a borehole and a formation, and may be reflected and recorded at sensors in an acoustic logging tool, such a sensors 207 in FIG. 2. The sensors may measure characteristics of the received waveforms that can be processed to determine characteristics of the surrounding formation.

In certain embodiments, according to aspects of the present disclosure, acoustic measurements may be used to determine certain characteristics of a transversely isotropic formation. A formation with transversely isotropy includes a symmetric axis perpendicular to which the formation has the same material properties. A transversely isotropic formation can be described by five elastic constants c₁₁, c₁₃, c₃₃, c₄₄, and c₆₆. Constants c₄₄ and c₆₆, the horizontal and vertical shear wave modulii, respectively, are of particular interest, as they are related to shear-wave propagation in a transversely isotropic medium. Notably, c44 and c66 can be used to determine Thomsen's shear wave anisotropy parameter gamma (γ=(c₆₆−c₄₄)/(2*c₄₄)).

According to aspects of the present disclosure, constant c₆₆ may be determined using both a Stoneley wave and a dipole flexural wave, with the dipole flexural wave being used to determine both constants c₄₄ and c₆₆. A Stoneley wave, also known as a surface wave or an interface wave, is generally associated with the interface between two solid media. Within a wellbore, the interface may include the face of the well itself, such that the Stoneley wave propagates along the face of the wellbore. Dipole flexural waves may propagate into a formation, in a plane transverse to the axis of the wellbore.

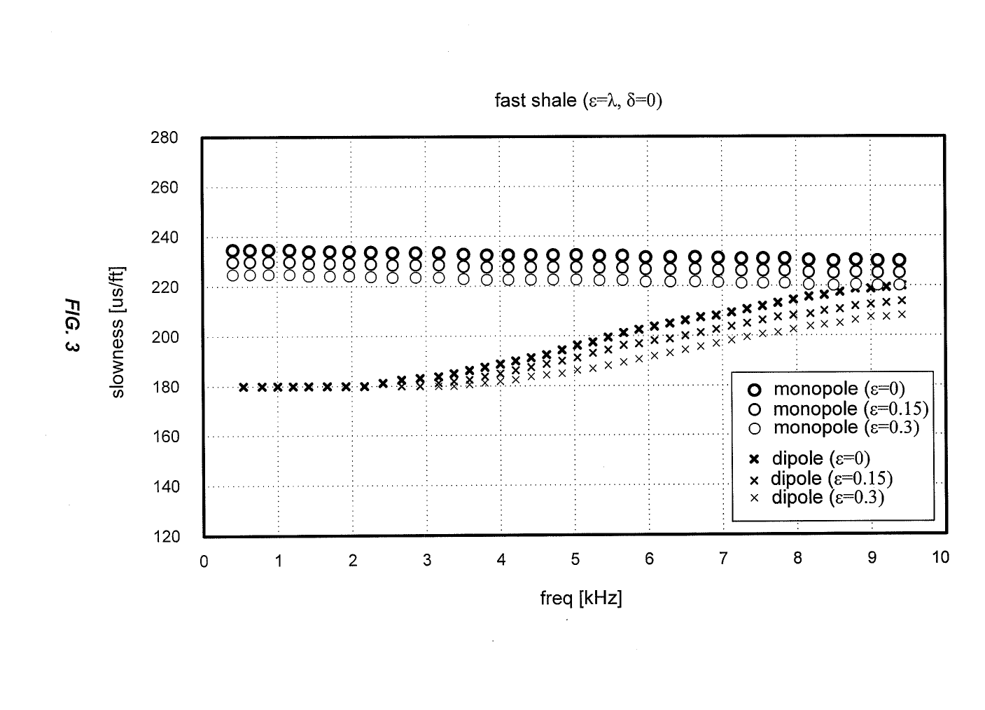

FIG. 3 illustrates a numerical calculation of Stoneley and dipole flexural wave dispersion in a vertically transversely isotropic formation. As previously mentioned, a vertically transversely isotropic formation describes a formation with physical properties which are symmetric within bands normal to the vertical axis. The anisotropy of a VTI formation describes the directional dependence of wave propagation speed within a particular band. Slowness dispersion describes the speed with which the acoustic waves propagate along or within the vertically transversely isotropic formation.

In FIG. 3, a P-wave anisotropy ε(ε=(c₁₁−c₃₃)/(2*c₃₃)) is set as equal with a shear wave anisotropy γ, ranging from 0 (no anisotropy) to 30 percent (ε=γ=0.3). The slowness results at different anisotropy values for both Stoneley (monopole) waves and dipole flexural waves are plotted versus a broad band frequency range (0 Hz to 10 kHz) of the Stoneley (monopole) waves and dipole flexural waves. As can be seen, both the Stoneley wave and the dipole flexural wave are sensitive to a shear wave anisotropy γ. Likewise, it can be seen that at low frequencies, including ultra low frequencies that are less than or equal to 100 Hz, the dipole flexural wave is insensitive to shear wave anisotropy γ, allowing for use of a low frequency portion of a dipole flexural wave to determine c₄₄. Because both a Stoneley wave and a dipole flexural wave are sensitive to shear wave anisotropy γ, both can be used to determine the vertical shear wave modulus c₆₆, according to the equation γ=((c₆₆−c₄₄)/(2*c₄₄)).

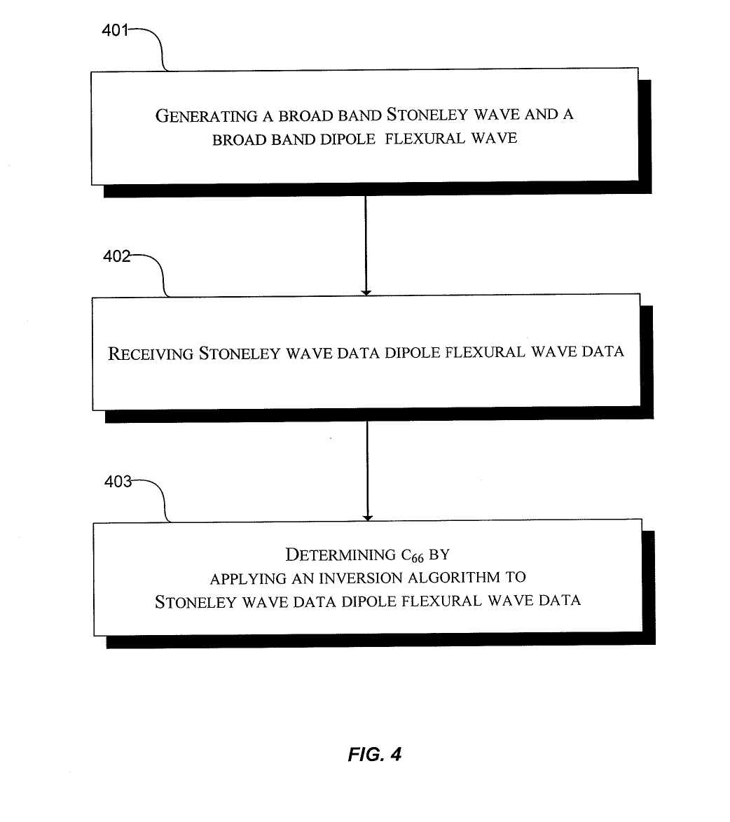

FIG. 4 illustrates an example method according to aspects of the present invention. Step 401 includes generating a broad band Stoneley wave and a broad band dipole flexural wave at a logging tool located within a wellbore. The logging tool may comprise the acoustic measurement system and tool described in FIG. 2. In certain embodiments, each of the Stoneley wave and the dipole flexural wave may comprise a waveform with a frequency range between one hundred hertz and 10 kHz, as shown in FIG. 3. A processor, such as a processor in an above ground control unit, may cause electronic equipment located within a wellbore to generate the acoustic signals. In certain embodiments, the waves may be transmitted into the formation by one or more transmitters, such as the transmitter in FIG. 2.

Step 402 may include receiving at the logging tool first data corresponding to the broad band Stoneley wave and second data corresponding to the broad band dipole flexural wave. The first and second data may include measurements of slowness or velocity values for the Stoneley and dipole flexural waveform within the formation, respectively. In certain embodiments, the values may be received at a plurality of sensors disposed on the surface of the logging tool. The measurements may be transmitted to a data acquisition unit located within the logging tool or within a control unit at the surface. The data acquisition unit may store the data for processing.

Step 403 may include determining a vertical shear wave constant, c₆₆, by at least applying an inversion algorithm to the first data and the second data. The determination may occur at a data processing unit, such as a processor, located in a control unit. The control unit may be located at the surface or within the logging tool. In certain embodiments, the inversion algorithm may include one of a stochastic inversion algorithm or a non-linear least squares inversion algorithm, as will be appreciated by one of ordinary skill in the art in view of this disclosure. In certain other embodiments, the inversion algorithm may include comparing a set of pre-calculated dispersion curves to the dispersion curves calculated for each of the Stoneley wave and the dipole flexural wave according to the recorded data, such as the dispersion curves shown in FIG. 3. Other inversion algorithms may be used, as will be appreciated by one of ordinary skill in view of this disclosure.

In certain other embodiments, the method may include a step of determining a horizontal shear wave modulus c₄₄ by applying an inversion algorithm to data corresponding to a low-frequency portion of the dipole flexural wave signal. In certain embodiments, the low frequency portion of the dipole flexural wave signal may be limited to frequencies within 0 Hz and 5 kHz.

In certain other embodiments, the method may include determining a drilling mud velocity by at least applying an inversion algorithm to the first data and the second data. As described above the Stoneley wave is sensitive to shear wave anisotropy gamma and the drilling mud velocity. In addition, as described above, the dipole flexural wave at higher frequencies is also sensitive to the shear wave anisotropy gamma and the drilling mud velocity. Accordingly, the drilling mud velocity can be calculated by at least applying an inversion algorithm to the first and second data.

The above method is advantageous in that it allows for a robust determination of the vertical shear wave modulus c₆₆. Specifically, by determining the vertical shear wave modulus c₆₆ using both a Stoneley wave (sensitive to drilling mud velocity) and a dipole flexural wave (insensitive to drilling mud velocity at low frequency), a more accurate and robust determination of vertical shear wave modulus c₆₆ can be determined as compared to current practices, where the Stoneley wave is used exclusively. A more accurate determination of vertical shear wave modulus c₆₆ affords for more accurate calculations of related geomechanical properties, including fracture strength and brittleness of a formation.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

1. A method for determining shear wave anisotropy in a vertically transversely isotropic formation, comprising:
generating a broad band Stoneley wave and a broad band dipole flexural wave at a logging tool located within a wellbore;
receiving at the logging tool first data corresponding to the broad band Stoneley wave and second data corresponding to the broad band dipole flexural wave;
determining a dispersion curve for each of the Stoneley wave and the dipole flexural wave; and
determining a vertical shear wave constant, c₆₆, by at least applying an inversion algorithm to the first data and the second data, wherein the inversion algorithm comprises comparing the determined dispersion curve for each of the Stoneley wave and the dipole flexural wave with a set of pre-calculated dispersion curves.

2. The method of claim 1, wherein the broad band dipole flexural wave and the broad band Stoneley wave include frequencies from less than or equal to 100 hertz to up to 10 kilohertz.

3. The method of claim 1, further comprising determining a horizontal shear wave constant, c₄₄, using a low frequency portion of the second data.

4. The method of claim 1, wherein the inversion algorithm comprises a look-up algorithm based on the set of pre-calculated dispersion curves.

5. The method of claim 1, further comprising determining a drilling mud velocity by at least applying an inversion algorithm to the first data and the second data.

6. The method of claim 3, wherein determining c₄₄ and c₆₆ includes using separately measured mud velocity.

7. A system for determining shear wave anisotropy in a formation, comprising:
a logging tool, wherein the logging tool includes a transmitter and at least one receiver;
a control unit coupled to the logging tool, wherein the control unit causes the transmitter to transmit a broad band Stoneley wave and a broad band dipole flexural wave into the formation;
a data acquisition unit, wherein the data acquisition unit receives a first data corresponding to the broad band Stoneley wave and a second data corresponding to the broad band dipole flexural wave; and
a data processing unit, wherein the data processing unit determines
a dispersion curve for each of the Stoneley wave and the dipole flexural wave; and
a vertical shear wave constant, c₆₆, by at least applying an inversion algorithm to the first data and the second data, wherein the inversion algorithm comprises comparing the determined dispersion curve for each of the Stoneley wave and the dipole flexural wave with a set of pre-calculated dispersion curves.

8. The system of claim 7, wherein the broad band dipole flexural wave and the broad band Stoneley wave include frequencies from less than or equal to 100 hertz to up to 10 kilohertz.

9. The system of claim 7, wherein the data processing unit further determines a horizontal shear wave constant, c₄₄, using a low frequency portion of the second data.

10. The system of claim 7, wherein the inversion algorithm comprises a look-up algorithm based on the set of pre-calculated dispersion curves.

11. The system of claim 7, wherein the data processing unit determines a drilling mud velocity by at least applying an inversion algorithm to the first data and the second data.

12. The system of claim 9 wherein determining c₄₄ and c₆₆ includes using separately measured mud velocity.

13. A method for determining shear wave anisotropy in a vertically transversely isotropic formation, comprising:
transmitting a broad band Stoneley wave and a broad band dipole flexural wave into a formation at least partially comprised of shale;
collecting first data corresponding to broad band Stoneley wave and second data corresponding to the broad band dipole flexural wave;
determining a dispersion curve for each of the Stoneley wave and the dipole flexural wave
calculating a vertical shear wave modulus, c₆₆, by applying an inversion algorithm to the first data and the second data, wherein the inversion algorithm comprises comparing the determined dispersion curve for each of the Stoneley wave and the dipole flexural wave with a set of pre-calculated dispersion curves; and
calculating a horizontal shear wave modulus, c₄₄, using a low frequency portion of the second data.

14. The method of claim 13, wherein the broad band dipole flexural wave includes frequencies from less than or equal to 100 hertz to up to 10 kilohertz.

15. The method of claim 13, wherein the low frequency portion of the second data corresponds to dipole flexural wave frequencies from 0 hertz to 5 kilohertz.

16. The method of claim 13, further comprising determining a drilling mud velocity by at least applying an inversion algorithm to the first data and the second data.
